(19) United States
(12) Patent Application Publication
(10) Pub. No.: US 2005/0264200 A1
(43) Pub. Date: Dec. 1, 2005

(54) Plasma display panel

(76) Inventors: Tae-Kyoung Kang, Suwon-si (KR); Yong-Jun Kim, Suwon-si (KR)

Correspondence Address: Robert E. Bushnell, Suite 300, 1522 K Street, N.W., Washington, DC, 20005, US

(21) Appl. No.: 11/135,489

(22) Filed: May 24, 2005

(30) Foreign Application Priority Data
May 25, 2004 (KR) 10-2004-0037352

(51) Int. Cl. H01J 17/49

(52) U.S. Cl. 313/582

(57) ABSTRACT

A plasma display panel (PDP) is characterized such that the strength of barrier ribs can be maintained, impurity gases can be easily exhausted, and a discharge gas can be smoothly filled in the discharge cells when manufacturing the PDP. The PDP includes: a transparent front substrate; a rear substrate disposed facing the front substrate; a plurality of discharge electrodes disposed between the front substrate and the rear substrate; a plurality of barrier ribs disposed between the front substrate and the rear substrate, and defining a plurality of discharge cells which are spaces for generating a discharge, the barrier ribs having side walls that define an exhaust channel formed in at least a portion between the discharge cells, at least one of the side walls having an arc-like shape; a phosphor layer disposed in each of the discharge cells; and a discharge gas filled in the discharge cells.

### CLAIM OF PRIORITY

This application makes reference to, incorporates the same herein, and claims all benefits accruing under 35 U.S.C. §119 from an application entitled PLASMA DISPLAY PANEL, earlier filed in the Korean Intellectual Property Office on 25 May 2004 and there duly assigned Serial No. 10-2004-0037352.

### BACKGROUND OF THE INVENTION

1. Technical Field

The present invention relates to a plasma display panel (PDP) and, more specifically, to a PDP in which an impurity gas can be easily exhausted and a discharge gas can be smoothly filled in discharge cells when manufacturing the PDP while maintaining the strength of barrier ribs of the PDP.

2. Related Art

Plasma display panels are display devices that display a predetermined image by exciting a phosphor material with ultra violet rays generated from a gas discharge, and they are expected to be the next generation of thin display devices since they can be manufactured with a large screen having high resolution.

PDPs can be classified into alternating current (AC) PDPs, direct current (DC) PDPs, and hybrid PDPs according to their structure and principle of operation. The AC PDPs and the DC PDPs can further be classified into facing discharge PDPs and surface discharge PDPs according to their discharge structure. Of these, the surface discharge PDPs are widely used.

As described above, a PDP is a display device for displaying an image using light emitted from a gas discharge. The display characteristics of the PDP are greatly affected by the ratio of components and the purity of the discharge gas in the PDP. Therefore, to manufacture a PDP that can display high quality images, the discharge gas filled in the PDP must have a predetermined mixing ratio and high purity.

However, impurity gases often enter and remain in the PDP in the course of manufacturing the PDP, and the impurity gases mix with a discharge gas injected into the PDP without being discharged to the outside. The contamination of the discharge gas can change the characteristics of discharge, and can eventually reduce the image display characteristics of the PDP.

Therefore, a PDP must be designed while considering the processes of discharging impurity gases and filling a discharge gas in the PDP.

### SUMMARY OF THE INVENTION

The present invention provides a plasma display panel (PDP) in which a high purity discharge gas can be filled by readily exhausting impurity gases generated when manufacturing the PDP while simultaneously filling a discharge gas into the discharge cells and maintaining the strength of barrier ribs at a predetermined level.

According to an aspect of the present invention, there is provided a PDP comprising: a transparent front substrate; a rear substrate disposed facing the front substrate; a plurality of discharge electrodes disposed between the front substrate and the rear substrate; a plurality of barrier ribs which are disposed between the front substrate and the rear substrate, and which define a plurality of discharge cells which are spaces generating a discharge, and which have side walls that define an exhaust channel formed in at least a portion between the discharge cells, at least one of the side walls having an arc-like shape; a phosphor layer disposed in each of the discharge cells; and a discharge gas filling the discharge cells.

The structure of the PDP allows for a high purity discharge gas to be filled in the discharge cells while simultaneously exhausting the impurity gases generated during the process of manufacturing the PDP through an exhaust channel. A possible reduction in the strength of the barrier ribs due to the exhaust channel can be prevented by forming both side walls of the barrier ribs, which form the exhaust channel, in an arc-like shape.

In the PDP, the barrier ribs may include vertical barrier ribs extending in one direction and horizontal barrier ribs extending in another direction and crossing the vertical barrier ribs. The horizontal cross-section of the discharge cells may be defined as an array by the vertical barrier ribs and the horizontal barrier ribs. Both side walls which define the exhaust channel may be vertical barrier ribs or horizontal barrier ribs.

The distance between the front portions of the side walls of the barrier ribs forming the exhaust channel, and the distance between rear portions of side walls of the barrier ribs forming the exhaust channel, may be less than the distance between the central portions of the side walls of the barrier ribs.

The distance between the front portions of the side walls of the barrier ribs may be greater than, or substantially identical to, the distance between the rear portions of the side walls of the barrier ribs.

The discharge electrodes may include sustaining electrode pairs disposed in parallel with each other on the rear surface of the front substrate, and address electrodes that cross the sustaining electrode pairs and are disposed on a front surface of the rear substrate.

The sustaining electrode pairs are covered by a front dielectric layer disposed on a rear surface of the front substrate, and the address electrodes are covered by a rear dielectric layer disposed on a front surface of the rear substrate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a broken perspective view of a PDP according to an embodiment of the present invention;

FIG. 2 is a plan cross-sectional view taken along line II-II of FIG. 1; and

FIG. 3 is a cross-sectional view taken along line III-III of FIG. 1.

### DETAILED DESCRIPTION OF THE INVENTION

The present invention will now be described more fully with reference to the accompanying drawings in which exemplary embodiments of the invention are shown.

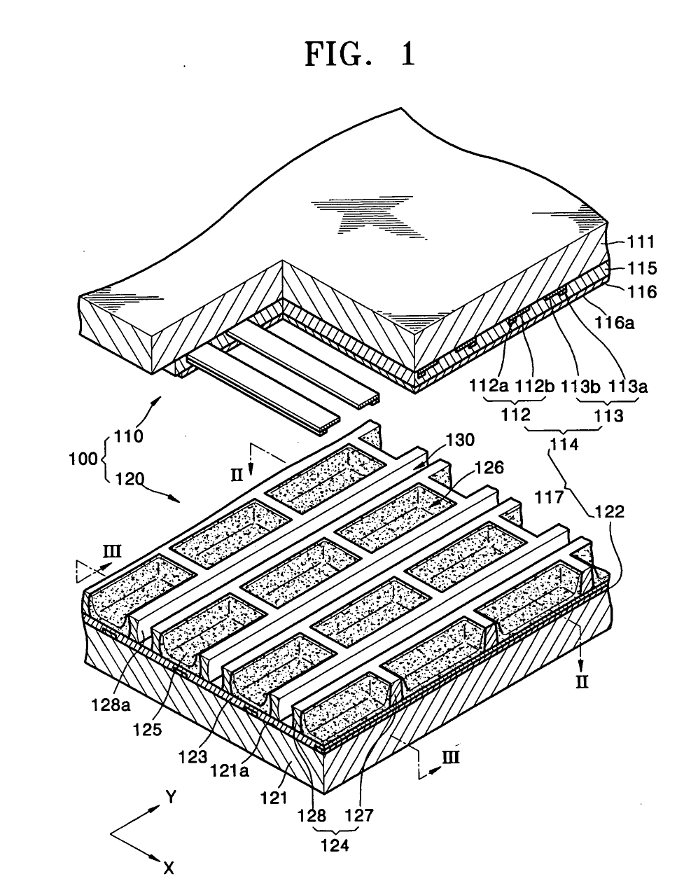

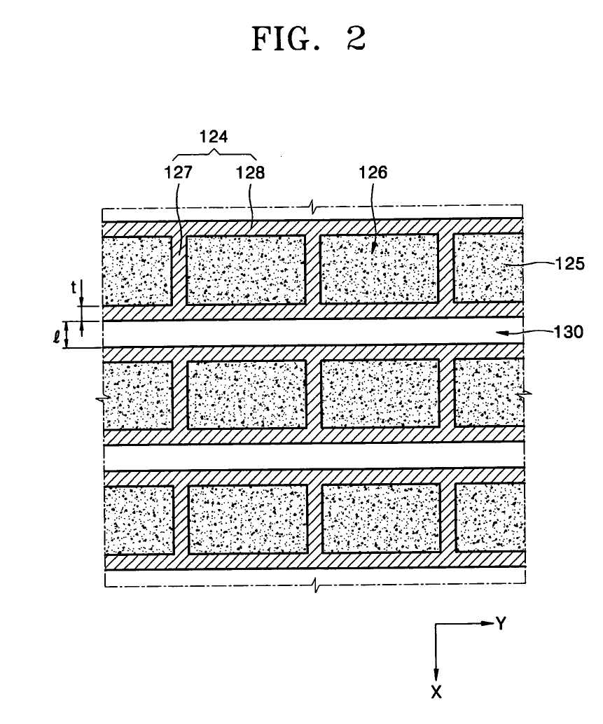

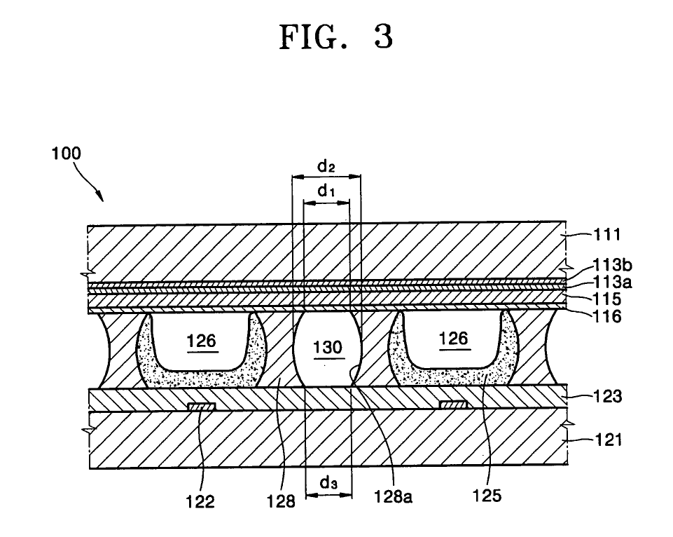

FIG. 1 is a broken perspective view of a PDP according to an embodiment of the present invention, while FIGS. 2 and 3 are cross-sectional views taken along lines II-II and III-III, respectively, of FIG. 1.

Referring to FIGS. 1 through 3, a PDP 100 comprises a front panel 110 and a rear panel 120. The front panel 110 includes a front substrate 111, a plurality of sustaining electrode pairs 114, each including an X electrode 113 and a Y electrode 112, which are parts of discharge electrodes 117 disposed on a rear surface of the front substrate 111, a front dielectric layer 115 that covers the sustaining electrode pairs 114, and a protective layer 116 that covers the front dielectric layer 115.

The accumulation of wall charge in the front dielectric layer 115 so as to generate a discharge on a rear surface of the front dielectric layer 115 is induced by a potential applied to the sustaining electrode pairs 114. Also, the protective layer 116, which is formed of MgO, facilitates discharging by increasing the emission of the second electrons, and increases the lifetime of the PDP 100 by protecting the sustaining electrode pairs 114 and the front dielectric layer 115.

The X electrodes 113 and the Y electrodes 112 include transparent electrodes 112b and 113b, respectively, for transmitting visible light. The transparent electrodes 112b and 113b are not used independently since the transparent electrodes 112b and 113b have high resistance. Therefore, the X electrode 113 and Y electrode 112 include bus electrodes 113a and 112a, respectively, formed of a high conductivity metal. The bus electrodes 112a and 113a are connected to connection cables (not shown) disposed on both sides of the PDP 100.

A pulse voltage for generating a sustaining discharge and a pulse voltage for generating an address discharge are applied to the Y electrodes 112. Individual pulse voltages for generating the address discharge can be applied to each of the Y electrodes 112. For this purpose, the Y electrodes 112 are designed for the application of an independent pulse voltage. The Y electrodes 112 are called “scan electrodes”.

On the other hand, a common pulse voltage or a bias voltage for generating a sustaining discharge in selected discharge cells 126 is applied to all of the X electrodes 113. Accordingly, the X electrodes 113 are designed for the application of an identical voltage to each of the X electrodes 113. The X electrodes 113 are called “common electrodes”.

The rear panel 120 includes a rear substrate 121, a plurality of address electrodes 122 crossing the sustaining electrode pairs 114, which are parts of the discharge electrodes 117, formed on a front surface 121a of the rear substrate 121, and a rear dielectric layer 123 that covers the address electrodes 122.

The rear dielectric layer 123 facilitates discharging of the address electrodes 122 induced by a predetermined voltage applied to the address electrodes 122, and protects the address electrodes 122 from colliding accelerated charged particles. However, when the address electrodes 122 are covered by a phosphor layer 125, which will be described later, the rear dielectric layer 123 is not necessary since the phosphor layer 125 can act as the dielectric layer.

The rear panel 120 includes a plurality of barrier ribs 124 disposed in front of the rear substrate 121, and more specifically, on the front surface of the rear dielectric layer 123, defining discharge cells 126 which are spaces generating discharge. At least one of two side walls 128a of the barrier ribs 124 defining the exhaust channel 130 has an arc-like shape.

Both side walls of the exhaust channel 130 preferably have an arc-like shape so as to enable all of the barrier ribs 124 to have uniform strength. However, it is unnecessary for both side walls of the barrier ribs to have arc-like shapes.

The barrier ribs 124 can include vertical barrier ribs 127 extending in one direction and horizontal barrier ribs 128 extending in another direction and crossing the vertical barrier ribs 127. The discharge cells 126 can be defined in an array by the vertical barrier ribs 127 and the horizontal barrier ribs 128.

However, the discharge cells 126 defined by the barrier ribs 124 are not necessarily in an array, and can be defined in a strip shape by the barrier ribs 124, without the vertical barrier ribs 127.

Also, the discharge cells 126 can have polygonal shapes, such as a rectangular shape or an octagonal shape. Therefore, in the present invention, the barrier ribs 124 are not necessarily partitioned by the vertical barrier ribs 127 and the horizontal barrier ribs 128, as depicted in FIG. 1, and the shapes of the discharge cells 126 are not necessarily defined in an array.

Two side surfaces 128a that form the exhaust channel 130 can be the side surfaces of the horizontal barrier ribs 128, and two side surfaces 128 that form the exhaust channel 130 can be the side surfaces of the vertical barrier ribs 127. That is, the formation of the exhaust channel 130 by the vertical barrier ribs 127 or the horizontal barrier ribs 128 affects only the direction of the exhaust channel 130, and not its function.

The exhaust channel 130 can be formed by both the vertical barrier ribs 127 and the horizontal barrier ribs 128. In this case, the exhaustion of the exhaust gas may be increased by virtue of the larger exhaust channel 130, but the pixel size may be reduced due to the increased gap between the discharge cells 126. Therefore, in the present embodiment, the case where both side walls 128a of the horizontal barrier ribs 128 form the exhaust channel 130 will be described. However, the present invention is not limited to the exhaust channel 130 extending in one direction.

The reason why both side walls 128a of the horizontal barrier ribs 128 are formed in an arc-like shape will be discussed later.

The discharge cells 126 are filled with a discharge gas in a vacuum state (approximately below 0.5 atm), and deformation of the PDP 100 due to the vacuum is prevented by the barrier ribs 124 disposed between the front panel 110 and the rear panel 120.

The discharge gas preferably includes approximately 10% (by volume) of Xe and Ne, He or Ar, or it includes more than two of these gases. Visible light is generated in a discharge cell when ultraviolet rays having wavelengths of 147 nm and 173 nm collide with the phosphor layer 125. The ultraviolet rays are generated when the energy level of the Xe gas contained in the discharge gas falls to a lower energy level after being excited by collision with the charged particles in the discharge cell. The ultraviolet rays having wavelengths of 147 nm and 173 nm generated by the excitation of the Xe gas are the most suitable wavelengths for generating visible light from the phosphor layer 125. Therefore, the phosphor material included in the phosphor layer 125 generates a large amount of visible light by being excited by the ultraviolet rays having the wavelengths of 147 nm and 173 nm.

The Ne gas, He gas, or Ar gas mixed with the Xe gas facilitates the discharge by the Xe gas through a penning effect that accelerates ionization of a different gas by forming another species in a meta-stable state. As a result of this cooperation between the gases, a plasma 8 discharge is generated, and then visible light is generated from the phosphor layer 125 by virtue of the plasma discharge, thus creating an image. Therefore, the components of the discharge gas, the mixing ratio of the gases, and whether impurity gases are included therein are important factors with respect to the display characteristics of the PDP.

The phosphor layer 125 disposed in the discharge cell 126 can include phosphor materials producing red, green, and blue light for realizing a color image, and the phosphor materials producing red, green, and blue light, included in the discharge cell 126 can form unit pixels. The phosphor layer 125 is formed when a paste, in which a phosphor material producing red, green, or blue light, a solvent, and a binder are mixed, is coated on a front surface of the rear dielectric layer 123 and a portion of side walls of the barrier ribs 124 in the discharge cell 126, and the resultant product is dried and annealed.

For example, a phosphor material that generates red light may be (Y,Gd)BO₃:Eu₃+, a phosphor material that generates green light may be Zn₂SiO₄:Mn₂+, and a phosphor material that generates blue light may be BaMgAl₁₀O₁₇:Eu₂+.

The function of the exhaust channel 130, and the structure of the barrier ribs 124, in connection with the function of the exhaust channel 130 of the PDP 100 will now be described with reference to FIG. 2, which is a plan cross-sectional view taken along line II-II of FIG. 1. The dispositions of the discharge cells 126 and the exhaust channel 130 of the PDP 100 of the present invention are depicted in FIG. 2. An annealing process for providing a predetermined strength to essential components, such as the barrier ribs 124 and the phosphor layer 125, is performed in the manufacturing process. Volatile materials, included in the materials comprising the barrier ribs 124 or the phosphor layer 125, evaporate in the form of an impurity gas, and some of the impurity gas is exhausted outside, while the other portion remains in the discharge cells 126. Even if there is no annealing process, many kinds of impurity gases can be produced when performing processes, such as etching or photolithography, for manufacturing the PDP, and these impurity gases may remain in the discharge cells 126.

If the impurity gas remains in the discharge cells 126, the characteristics of the discharge gas which will be supplied in a subsequent process to the discharge space can be altered by mixing with the impurity gas. When the discharge gas is contaminated by the impurity gas, as described above, the display characteristics of the PDP are degraded.

Moreover, if the discharge gas is contaminated by the impurity gas, a protective layer 116 formed of MgO and disposed on a rear surface of the front dielectric layer can be stained due to chemical reaction between the discharge gas and the impurity gas in the course of plasma discharging, or an unexpected problem may occur. These problems can reduce the quality and the lifetime of the PDP.

In consideration of the problems caused by the existence of the impurity gas, in a process for manufacturing a PDP, it is important to fill the discharge gas in the discharge cells after reducing the amount of impurity gas below a predetermined level.

The exhaustion of the impurity gas and the filling of the discharge gas can be performed separately or simultaneously. When performed simultaneously, the discharge gas is filled using a vacuum generated by the exhaustion of the impurity gas. This method is widely used, and will be described herein, although the present invention is not limited thereto.

The exhaust channel 130 may be formed in a space between the discharge cells extending in a Y direction so as to allow the exhaustion of the impurity gases and the filling of the discharge gas to be performed smoothly. At this point, the exhaust gas in the discharge cells 126 is ventilated to the outside of the PDP through a gas outlet (not shown) formed at an end of the PDP when forming the exhaust channel 130, and the discharge gas is filled in the discharge cells 126 through a gas inlet (not shown) formed at the other end of the PDP.

The impurity gases in the discharge cells 126 are ventilated to the exhaust channel 130 through a gap formed between the barrier rib and the front panel, and the discharge gas can be filled through this gap. As the time used to ventilate the impurity gas and fill the discharge gas increases, the efficiency of the process of manufacturing the PDP decreases. Therefore, a short time for ventilating the impurity gas and filling the discharge gas is preferable. The time to ventilate the impurity gas and fill the discharge gas is largely dependent on the characteristic of the exhaust channel 130.

The flow rate of a fluid is proportional to the velocity of the fluid and the cross-sectional area of the fluid flow. Therefore, as the cross-sectional area of the exhaust channel 130 increases and the velocity of the impurity gases and the discharge gas increases, the time required to ventilate the impurity gas and to fill the discharge gas is reduced.

However, when the distance 1 between the discharge cells 126 increases, the volume of the discharge cells 126 decreases or the display characteristic of the PDP 100 can be degraded due to the increased distance 1 between the discharge cells 126. Therefore, there is a limit to the increase in the distance 1 between the discharge cells 126.

To increase the distance 1 between the discharge cells 126, a reduction of the thickness t of the horizontal barrier ribs 128 can be considered. However, if the thickness t of the horizontal barrier ribs 128 is reduced below a certain limit, the horizontal barrier ribs 128 do not have enough strength to withstand the vacuum pressure generated by the discharge gas. That is, there is also a limit to the amount that the thickness t of the horizontal barrier ribs 128 can be reduced. Therefore, both side walls 128a of the horizontal barrier ribs 128 that define the exhaust channel 130 have an arc-like shape so as to increase the cross-sectional area of the exhaust channel 130 in consideration of the limitation on the increase in the cross-sectional area of the exhaust channel 130.

The arc-like shape will be described in detail with reference to FIG. 3, which is a cross-sectional view taken along line III-III of FIG. 1. The PDP 100 includes horizontal barrier ribs 128 having an arc-like shape. The arc-like shape is a recessed shape such that the both side walls 128a of the horizontal barrier ribs 128 have a predetermined curvature. The cross-sectional area of the exhaust channel 130 formed in an arc-like shape is greater than the cross-sectional area of the exhaust channel when the horizontal barrier ribs 128 have a rectangular shape or a trapezoidal shape, and therefore, the velocity of the exhaust gas and the filling discharge gas is increased.

If both side walls 128a of the horizontal barrier ribs 128 have a recessed shape with a predetermined curvature, the thickness t of the central portion of the horizontal barrier ribs 128 can be reduced while the strength of the horizontal barrier ribs 128 is maintained since the structural characteristic of the horizontal barrier ribs 128 is stabilized by using the arc-like shape. This is because a breakdown of the horizontal barrier ribs 128 can be prevented by a reinforcing strength at both ends of the horizontal barrier ribs 128, instead of the central portion of the horizontal barrier ribs 128, since the shear force of a beam is greater further from the central portion of the horizontal barrier ribs 128. This is the same principle that occurs in an I-beam, in which the cross-sectional area of the central portion of the I-beam does not affect the breakdown of the overall structure.

To obtain a further stabilized structure with the arc-like shaped barrier ribs, the distance d2 between the barrier ribs at the central portion of the horizontal barrier ribs 128 can be greater than each of the distances d1 and d3 between the front and rear portions, respectively, of the horizontal barrier ribs 128. It is preferable that the distance d3 between the rear portion be less than, or substantially identical to, the distance d1 between the horizontal barrier ribs 128 when considering the structural characteristics.

The exhaustion of the impurity gas and the filling of the discharge gas depend on an external device used, and the velocity of the fluids is limited by the characteristics of the external device. Therefore, the larger the cross-sectional area of the exhaust channel 130, the less time there is in ventilating the impurity gas and filling the discharge gas. The cross-sectional area of the exhaust channel 130 is determined according to the height of the barrier rib and the width of the exhaust channel 130, that is, the distance d1 between the horizontal barrier ribs 128.

The height of the barrier rib is limited by the design characteristics of the volume of the discharge cells 126 and the thickness of the PDP 100. Therefore, the cross-sectional area of the exhaust channel 130 can be varied by changing the distance 1 of the horizontal barrier ribs 128.

The present invention provides a PDP having an increased lifetime by effectively performing the exhaustion of impurity gas and the filling of discharge gas, which is an essential process for forming the PDP, without reducing the strength of barrier ribs, which can otherwise occur during a process for ventilating impurity gas and filling discharge gas in discharge cells.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A plasma display panel (PDP), comprising:
a front substrate;
a rear substrate disposed facing the front substrate;
a plurality of discharge electrodes disposed between the front substrate and the rear substrate;
a plurality of barrier ribs disposed between the front substrate and the rear substrate, and defining a plurality of discharge cells which are spaces for generating a discharge, the plurality of barrier ribs having side walls that define an exhaust channel formed in at least a portion between the discharge cells, at least one of the side walls having an arc-like shape;
a phosphor layer disposed in each of the discharge cells; and
a discharge gas filled in the discharge cells.

2. The PDP of claim 1, wherein the barrier ribs include vertical barrier ribs extending in one direction and horizontal barrier ribs extending in another direction and crossing the vertical barrier ribs.

3. The PDP of claim 2, wherein a horizontal cross-section of the discharge cells is defined as an array by the vertical barrier ribs and the horizontal barrier ribs.

4. The PDP of claim 2, wherein the side walls that define the exhaust channel are part of the vertical barrier ribs.

5. The PDP of claim 2, wherein the side walls that define the exhaust channel are part of the horizontal barrier ribs.

6. The PDP of claim 1, wherein each of a distance between front portions of the side walls that define the exhaust channel and a distance between rear portions of the side walls that define the exhaust channel is less than a distance between central portions of the side walls that define the exhaust channel.

7. The PDP of claim 6, wherein the distance between the front portions of the side walls that define the exhaust channel is greater than the distance between the rear portions of the side walls that define the exhaust channel.

8. The PDP of claim 6, wherein the distance between the front portions of the side walls that define the exhaust channel is substantially identical to the distance between the rear portions of the side walls that define the exhaust channel.

9. The PDP of claim 1, wherein the discharge electrodes include sustaining electrode pairs disposed in parallel with each other on a rear surface of the front substrate, and address electrodes which cross the sustaining electrode pairs and which are disposed on a front surface of the rear substrate.

10. The PDP of claim 9, wherein the sustaining electrode pairs are covered by a front dielectric layer disposed on the rear surface of the front substrate, and the address electrodes are covered by a rear dielectric layer disposed on the front surface of the rear substrate.

11. A plasma display panel (PDP), comprising:
a transparent front substrate;
a rear substrate disposed facing the front substrate;
a plurality of discharge electrodes disposed between the front substrate and the rear substrate;
a plurality of barrier ribs disposed between the front substrate and the rear substrate, and defining a plurality of discharge cells which are spaces for generating a discharge, the plurality of barrier ribs having side walls that define an exhaust channel formed in at least a portion between the discharge cells, at least one of the side walls having an arc-like shape; and
a discharge gas filled in the discharge cells.

12. The PDP of claim 11, wherein the barrier ribs include vertical barrier ribs extending in one direction and horizontal barrier ribs extending in another direction and crossing the vertical barrier ribs.

13. The PDP of claim 12, wherein a horizontal cross-section of the discharge cells is defined as an array by the vertical barrier ribs and the horizontal barrier ribs.

14. The PDP of claim 12, wherein the side walls that define the exhaust channel are part of the vertical barrier ribs.

15. The PDP of claim 12, wherein the side walls that define the exhaust channel are part of the horizontal barrier ribs.

16. The PDP of claim 11, wherein each of a distance between front portions of the side walls that define the exhaust channel and a distance between rear portions of the side walls that define the exhaust channel is less than a distance between central portions of the side walls that define the exhaust channel.

17. The PDP of claim 16, wherein the distance between the front portions of the side walls that define the exhaust channel is greater than the distance between the rear portions of the side walls that define the exhaust channel.

18. The PDP of claim 16, wherein the distance between the front portions of the side walls that define the exhaust channel is substantially identical to the distance between the rear portions of the side walls that define the exhaust channel.

19. The PDP of claim 11, wherein the discharge electrodes include sustaining electrode pairs disposed in parallel with each other on a rear surface of the front substrate, and address electrodes which cross the sustaining electrode pairs and which are disposed on a front surface of the rear substrate.

20. The PDP of claim 19, wherein the sustaining electrode pairs are covered by a front dielectric layer disposed on the rear surface of the front substrate, and the address electrodes are covered by a rear dielectric layer disposed on the front surface of the rear substrate.
